(19) United States
(12) Patent Application Publication
(10) Pub. No.: US 2025/0110255 A1
(43) Pub. Date: Apr. 3, 2025

(54) METHOD OF DETERMINING METEOROLOGICAL INFORMATION, ELECTRONIC DEVICE AND STORAGE MEDIUM

(71) Applicant: Beijing Baidu Netcom Science Technology Co., Ltd., Beijing (CN)

(72) Inventors: Jingbo ZHOU, Beijing (CN); Pengfei REN, Beijing (CN)

(21) Appl. No.: 18/957,351

(22) Filed: Nov. 22, 2024

(30) Foreign Application Priority Data
Sep. 18, 2024 (CN) 202411304163.9

(51) Int. Cl. G01W 1/00; G06F 40/166

(52) U.S. Cl. CPC G01W 1/00; G06F 40/166

(57) ABSTRACT

A method of determining meteorological information, an electronic device and a storage medium are provided, which relate to a field of artificial intelligence technology, and in particular to fields of deep learning and large models. The method includes performing a feature extraction on meteorological raster data of a target region within a target time period to obtain a meteorological feature vector; inputting to-be-processed meteorological data of the target region within the target time period into a large language model to obtain a text summary including a meteorological information determination manner; performing an information enhancement processing on the meteorological feature vector by using the text summary to obtain an information enhancement result; and performing a self-attention processing on the information enhancement result to obtain a meteorological information determination result output for the to-be-processed meteorological data.

### CROSS-REFERENCE TO RELATED APPLICATION(S)

This application claims the benefit of Chinese Patent Application No. 202411304163.9 filed on Sep. 18, 2024, the whole disclosure of which is incorporated herein by reference.

### TECHNICAL FIELD

The present disclosure relates to a field of artificial intelligence technology, in particular to fields of deep learning and large models, and specifically to a method of determining meteorological information, an electronic device and a storage medium.

### BACKGROUND

Meteorology includes information such as weather and climate. With the frequent occurrence of extreme weather events and the impact of climate change around the world, the importance of weather and climate modeling has become increasingly prominent. With the increasing public attention, the demand for weather forecasts that may reduce disaster losses and climate predictions that support long-term policy planning has become more urgent.

### SUMMARY

The present disclosure provides a method of determining meteorological information, an electronic device and a storage medium.

According to an aspect of the present disclosure, a method of determining meteorological information is provided, including: performing a feature extraction on meteorological raster data of a target region within a target time period to obtain a meteorological feature vector; inputting to-be-processed meteorological data of the target region within the target time period into a large language model to obtain a text summary including a meteorological information determination manner; performing an information enhancement processing on the meteorological feature vector by using the text summary to obtain an information enhancement result; and performing a self-attention processing on the information enhancement result to obtain a meteorological information determination result output for the to-be-processed meteorological data.

According to another aspect of the present disclosure, an electronic device is provided, including: at least one processor; and a memory communicatively connected with the at least one processor; where the memory stores instructions executable by the at least one processor, and the instructions, when executed by the at least one processor, cause the at least one processor to perform the method of determining meteorological information.

According to another aspect of the present disclosure, a non-transitory computer-readable storage medium storing computer instructions is provided, where the computer instructions are configured to cause a computer to perform the method of determining meteorological information.

It should be understood that the content described in this section is not intended to identify key or important features of the embodiments of the present disclosure, nor is it intended to limit the scope of the present disclosure. Other features of the present disclosure will be easily understood through the following description.

### BRIEF DESCRIPTION OF THE DRAWINGS

The drawings are used to better understand the solutions, and do not constitute a limitation to the present disclosure. In the drawings:

FIG. 1 schematically shows an exemplary system architecture to which a method of determining meteorological information and an apparatus of determining meteorological information may be applied according to the embodiments of the present disclosure;

FIG. 2 schematically shows a flow chart of a method of determining meteorological information according to the embodiments of the present disclosure;

FIG. 3A schematically shows a framework diagram of a meteorological deep learning model enhanced based on LLM text according to the embodiments of the present disclosure;

FIG. 3B schematically shows an overall architecture diagram of a meteorological deep learning model enhanced based on LLM text according to the embodiments of the present disclosure;

FIG. 4 schematically shows a block diagram of an apparatus of determining meteorological information according to the embodiments of the present disclosure; and

FIG. 5 shows a block diagram of an electronic device that may be used to implement the embodiments of the present disclosure.

### DETAILED DESCRIPTION OF EMBODIMENTS

Hereinafter, exemplary embodiments of the present disclosure will be described with reference to the drawings, which include various details of the embodiments of the present disclosure to aid in understanding. Therefore, those skilled in the art should recognize that various changes and modifications may be made to the embodiments described herein without departing from the scope and spirit of the disclosure. Similarly, for clarity and conciseness, descriptions of well-known functions and structures have been omitted in the following description.

It should be noted that, collecting, storing, using, processing, transmitting, providing, disclosing and applying of the relevant data involved in the technical solution of the present disclosure comply with the provisions of relevant laws and regulations, take the necessary confidentiality measures. and do not violate public order and good customs.

In the technical solution of the present disclosure, the authorization or consent of user is obtained before obtaining or collecting the personal information of the user.

In the related art, physics numerical models based on atmospheric and data-driven deep learning models are used to model weather and climate.

Physics numerical models based on atmospheric are designed to simulate nonlinear dynamics and complex interactions between multiple variables. The most representative is the GCM (general circulation models). GCM is a system of differential equations related to the flow of energy and matter in the atmosphere, land, and oceans, which may be integrated over time to obtain forecasts of atmospheric variables.

In the process of implementing the concept of the present disclosure, the inventors found that although the physics numerical model based on atmospheric is the most widely used in practice, this method is a computationally intensive model with poor ability to accurately represent physical processes and initial conditions at a fine granularity, and may not be expanded in terms of data scale and lacks flexibility. These factors limit the using in many scenarios, especially in the rapid simulation of atmospheric variables on very short time scales such as a few hours, or in the accurate simulation of atmospheric variables on long time scales such as a few hours.

For the data-driven deep learning models, the key idea is to train deep neural networks to predict target atmospheric variables, and use decades of historical global data sets for reanalysis. Unlike GCM, the networks are not explicitly based on physics, but are trained for specific predictive modeling tasks.

In the process of implementing the concept of the present disclosure, the inventors found that the data-driven deep learning models are trained for specific predictive modeling tasks and may not meet the requirements of spatiotemporal task training for heterogeneous data sets, so the model lacks the versatility of earth system science. In addition, homogeneous data set training makes it difficult to fully mine climate information and effectively utilize its hidden features. These reasons lead to poor performance of data-driven deep learning models in the prediction of extreme weather events and long-term climate forecasts under limited spatiotemporal supervision and computing budget.

In summary, the physics numerical model based on atmospheric only supports expansion in computing, but may not be flexibly applied to data sets of different sizes. The data-driven models are usually limited to specific tasks and lack versatility in different practical scenarios.

Therefore, it is critical to explore how to effectively use heterogeneous climate data and fully exploit its characteristics.

The present disclosure provides a method of determining meteorological information, an apparatus of determining meteorological information, an electronic device and a storage medium, which relates to a field of artificial intelligence technology, and especially to fields of deep learning and large models, etc. The method of determining meteorological information includes: performing a feature extraction on meteorological raster data of a target region within a target time period to obtain a meteorological feature vector; inputting to-be-processed meteorological data of the target region within the target time period into a large language model to obtain a text summary including a meteorological information determination manner; performing an information enhancement processing on the meteorological feature vector by using the text summary to obtain an information enhancement result; and performing a self-attention processing on the information enhancement result to obtain a meteorological information determination result output for the to-be-processed meteorological data.

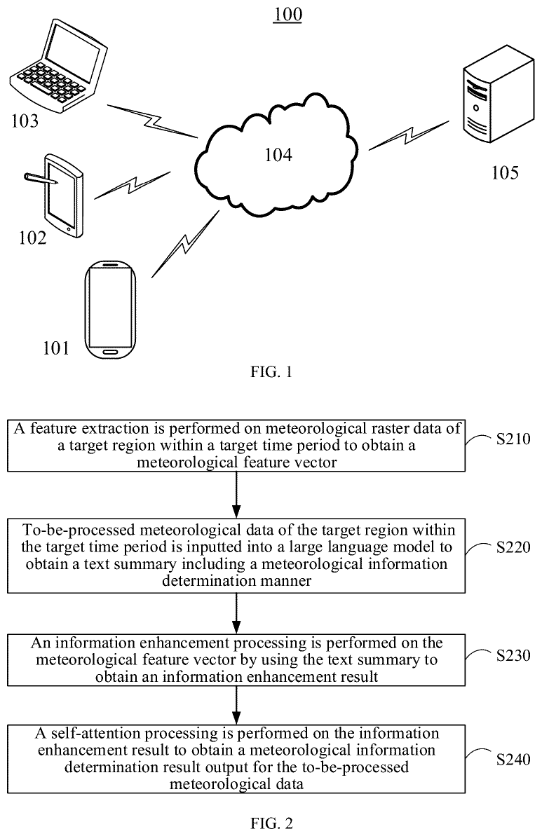

FIG. 1 schematically shows an exemplary system architecture to which a method of determining meteorological information and an apparatus of determining meteorological information may be applied according to the embodiments of the present disclosure.

It should be noted that FIG. 1 is only an example of a system architecture to which the embodiments of the present disclosure may be applied, in order to help those skilled in the art understand the technical content of the present disclosure, but it does not mean that the embodiments of the present disclosure cannot be used in other devices, systems, environments or scenarios. For example, in another embodiment, the exemplary system architecture to which the method of determining meteorological information and the apparatus of determining meteorological information may be applied may include a terminal device, but the terminal device may implement the method of determining meteorological information and the apparatus of determining meteorological information provided by the embodiments of the present disclosure without interacting with the server.

As shown in FIG. 1, the system architecture 100 according to this embodiment may include a first terminal device 101, a second terminal device 102, a third terminal device 103, a network 104 and a server 105. The network 104 is used to provide a medium for a communication link between the first terminal device 101, the second terminal device 102, the third terminal device 103 and the server 105. The network 104 may include various connection types, such as wired and/or wireless communication links, etc.

The user may use the first terminal device 101, the second terminal device 102, and the third terminal device 103 to interact with the server 105 through the network 104 to receive or send messages, etc. Various communication client applications may be installed on the first terminal device 101, the second terminal device 102, and the third terminal device 103, such as knowledge reading applications, web browser applications, search applications, instant messaging tools, email clients, and/or social platform software, etc. (only as examples).

The first terminal device 101, the second terminal device 102, and the third terminal device 103 may be various electronic devices with display screens and supporting web browsing, including but not limited to smart phones, tablet computers, laptop portable computers, and desktop computers, etc.

The server 105 may be a server that provides various services, such as a background management server that provides support for the content browsed by the user using the first terminal device 101, the second terminal device 102, and the third terminal device 103 (only as an example). The background management server may analyze and process the received data such as user requests, and feedback the processing results (such as web pages, information, or data obtained or generated according to user requests) to the terminal device. The server may also be a cloud server, also known as a cloud computing server or cloud host, which is a host product in the cloud computing service system to solve the defects of difficult management and weak business scalability in traditional physical hosts and VPS services (“Virtual Private Server”, or “VPS” for short). The server may also be a server of a distributed system, or a server combined with a blockchain.

It should be noted that the method of determining meteorological information provided in the embodiments of the present disclosure may generally be executed by the first terminal device 101, the second terminal device 102, or the third terminal device 103. Accordingly, the content processing apparatus provided in the embodiment of the present disclosure may also be provided in the first terminal device 101, the second terminal device 102, or the third terminal device 103.

Alternatively, the method of determining meteorological information provided in the embodiments of the present disclosure may also be generally performed by the server 105. Accordingly, the apparatus of determining meteorological information provided in the embodiments of the present disclosure may generally be arranged in the server 105. The method of determining meteorological information provided in the embodiments of the present disclosure may also be performed by a server or server cluster that is different from the server 105 and may communicate with the first terminal device 101, the second terminal device 102, the third terminal device 103 and/or the server 105. Accordingly, the apparatus of determining meteorological information provided in the embodiments of the present disclosure may also be arranged in a server or server cluster that is different from the server 105 and may communicate with the first terminal device 101, the second terminal device 102, the third terminal device 103 and/or the server 105.

For example, when determining a meteorological information, the first terminal device 101, the second terminal device 102, and the third terminal device 103 may obtain meteorological raster data and to-be-processed meteorological data in a target region within a target time period, and send the obtained meteorological raster data and to-be-processed meteorological data to the server 105, the server 105 may perform a feature extraction on the meteorological raster data to obtain a meteorological feature vector; input the to-be-processed meteorological data into a large language model to obtain a text summary including a meteorological information determination manner; perform an information enhancement processing on the meteorological feature vector by using the text summary to obtain an information enhancement result; and perform a self-attention processing on the information enhancement result to obtain a meteorological information determination result output for the to-be-processed meteorological data. Alternatively, a server or server cluster that may communicate with the first terminal device 101, the second terminal device 102, the third terminal device 103 and/or the server 105 analyzes the meteorological raster data and the to-be-processed meteorological data, and obtains a meteorological information determination result output for the to-be-processed meteorological data.

It should be understood that the number of terminal devices, networks and servers in FIG. 1 is only illustrative. Any number of terminal devices, networks and servers may be provided according to implementation requirements.

FIG. 2 schematically shows a flow chart of a method of determining meteorological information according to the embodiments of the present disclosure.

As shown in FIG. 2, the method includes operations S210 to S240.

In operation S210, a feature extraction is performed on meteorological raster data of a target region within a target time period to obtain a meteorological feature vector.

According to the embodiments of the present disclosure, the meteorological raster data may be grid data in NC (a common grid data format for meteorological data) format downloaded based on climate data sets such as CMIP6 (Coupled Model Intercomparison Project) and ERA5 (the fifth generation atmospheric reanalysis data set). The number of grid rows and columns of the grid data may be determined by the longitude and latitude information of the earth grid. Each raster in the meteorological raster data may include, for example, temperature, sea level pressure, humidity, wind speed, radiation, precipitation, snow depth, sunshine hours, etc. at each longitude and latitude position, and may not be limited thereto.

According to the embodiments of the present disclosure, any form of feature extraction module with feature extraction function may be used to extract the feature and obtain the meteorological feature vector. A pre-trained deep learning model may also be used to extract the feature and obtain the meteorological feature vector, which is not limited here. The deep learning model may include, for example, a pre-trained large unsupervised basic model or other neural network model, and may not be limited thereto. By using the pre-trained large unsupervised basic model for feature extraction, the supervision bottleneck problem may be alleviated and the generalization ability of the model may be improved.

In operation S220, to-be-processed meteorological data of the target region within the target time period is inputted into a large language model to obtain a text summary including a meteorological information determination manner.

According to the embodiments of the present disclosure, the to-be-processed meteorological data may characterize basic meteorological data adapted to specific business needs, which is collected from climate data sets such as CMIP6 and EAR5 according to business needs. Due to the diversity of business needs, the data structure, data content, etc. of the basic meteorological data obtained for different business needs may be different. For example, the to-be-processed meteorological data may be meteorological raster data, or may be array-type basic meteorological data that only includes meteorological attributes required by business needs, or may include location information of the target region, which is not limited here.

According to the embodiments of the present disclosure, the large language model may be a large language model (LLM) generated by pre-training, which may output the text summary including the meteorological information determination manner based on the to-be-processed meteorological data as input. The text summary may only include text information characterizing the meteorological information determination manner, such as determining meteorological information for a certain period of time, a certain location, a certain meteorological attribute, etc. The text summary may further include text information marking the meteorological information determination manner and text information characterizing part or all of the to-be-processed meteorological information, and may not be limited thereto.

In operation S230, an information enhancement processing is performed on the meteorological feature vector by using the text summary to obtain an information enhancement result.

According to the embodiments of the present disclosure, the information enhancement result may characterize the result of data enhancement on the meteorological raster data using the text summary. In this operation, the data enhancement method may be expressed as: fusing the text summary with the meteorological raster data, and extracting a feature from the fusion result of the text summary and the meteorological raster data, to obtain the information enhancement result. The data enhancement method may also be expressed as: extracting a feature from the text summary, and fusing the feature extraction result of the text summary with the meteorological feature vector, to obtain the information enhancement result.

It should be noted that the above-mentioned information enhancement method is only an exemplary embodiment, but is not limited thereto, and may also include other information enhancement methods known in the art, as long as the information enhancement result may be obtained.

In operation S240, a self-attention processing is performed on the information enhancement result to obtain a meteorological information determination result output for the to-be-processed meteorological data.

According to the embodiments of the present disclosure, a transformer (a neural network model based on a self-attention mechanism) may be used to perform an encoding operation based on a self-attention mechanism on the information enhancement result to obtain an encoding vector. Next, the encoding vector may be decoded based on a self-attention mechanism to obtain the meteorological information determination result.

It should be noted that the use of the transformer for self-attention processing is only an exemplary embodiment, but is not limited thereto, and other models based on a self-attention mechanism known in the art may also be used, as long as self-attention processing may be performed.

According to the embodiments of the present disclosure, the meteorological information determination result may characterize the result obtained after processing the to-be-processed meteorological data based on the meteorological raster data and the meteorological information determination method in the text summary.

Through the above-mentioned embodiments of the present disclosure, the large language model is used to process the to-be-processed meteorological data, which helps to better extract the text modal information of the to-be-processed meteorological data. The obtained text summary may contain the core points and key information in the to-be-processed meteorological data. By using the text summary as an enhanced modality and performing information enhancement processing on the meteorological feature vector, it is possible to focus on these core points and key information on the basis of the meteorological feature vector, accurately capture the intention and theme in the text summary, better mine the potential features in the meteorological raster data and the to-be-processed data, and obtain the meteorological information determination result that conforms to the intention and theme in the text summary output for the to-be-processed meteorological data. In addition, since the text summary is obtained by processing the to-be-processed meteorological data using the large language model, when implementing the relevant operations of this method, the data modality of the to-be-processed meteorological data may be not limited, and the full mining of various types of heterogeneous meteorological data may be effectively realized, so that this method may be flexibly applied to data sets of different sizes and implement universality in multimodal data scenarios.

The method shown in FIG. 2 is further described below in conjunction with the specific embodiments.

According to the embodiments of the present disclosure, based on the advantage of using LLM in the above method to deeply mine text information, a meteorological deep learning model enhanced based on LLM text may also be constructed. By pre-training the meteorological deep learning model enhanced based on LLM text, the method of determining meteorological information may be accurately performed, including performing the above operations S210 to S240.

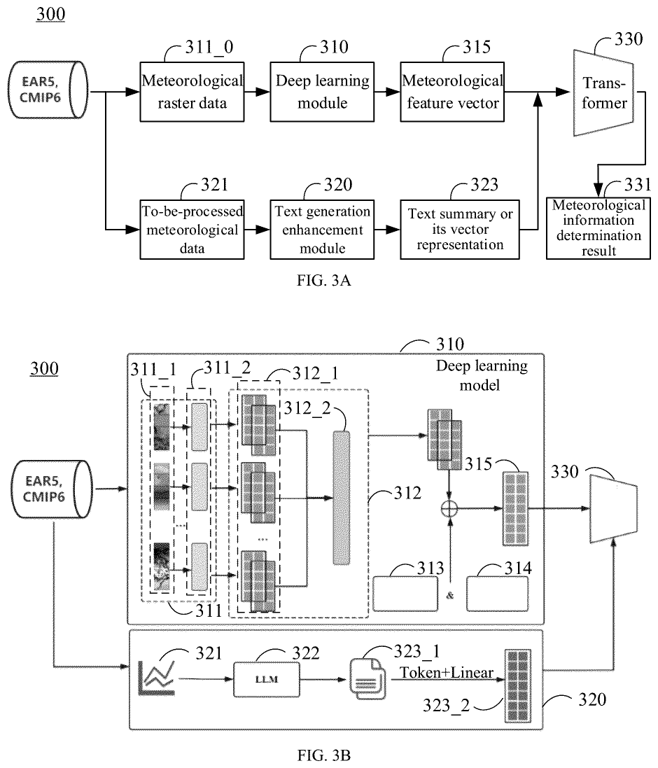

FIG. 3A schematically shows a framework diagram of a meteorological deep learning model enhanced based on LLM text according to the embodiments of the present disclosure.

As shown in FIG. 3A, the meteorological deep learning model 300 enhanced based on LLM text may be a model obtained by modeling using ViT (Vision Transformers, a deep learning model based on the Transformer architecture), including a deep learning module 310, a text generation enhancement module 320, and a transformer 330.

According to the embodiments of the present disclosure, the deep learning module 310 may receive meteorological raster data 311_0 collected based on EAR5 and CMIP6 as input, perform feature extraction, and output a meteorological feature vector 315. The text generation enhancement module 320 may receive the to-be-processed meteorological data 321 as input, and output a text summary or a text summary vector representation 323. The transformer 330 may receive the meteorological feature vector 315 and the text summary or the text summary vector representation 323, perform self-attention processing, and obtain a meteorological information determination result 331.

To achieve the above purpose, the meteorological deep learning model architecture shown in FIG. 3A may be pre-trained based on the self-supervision target of climate data sets such as CMIP6 and ERA5, including: the text summary of the to-be-processed meteorological data generated by LLM is used as the enhanced modality, and is input into the ViT architecture together with the meteorological feature vector for pre-training. The fine-tuning may be performed based on various downstream tasks related to weather and climate, thereby making full use of data to improve forecasting results.

FIG. 3B schematically shows an overall architecture diagram of a meteorological deep learning model enhanced based on LLM text according to the embodiments of the present disclosure.

As shown in FIG. 3B, the deep learning module 310 may include a variable tokenization module 311 and a variable aggregation module 312, and may not be limited thereto. The deep learning module 310 is designed as a generalizable deep learning model that may input heterogeneous data sets of different variables and process heterogeneous data of different dimensions.

According to the embodiments of the present disclosure, after obtaining the meteorological raster data, the above operation S210 may be performed in combination with the deep learning module 310 in the meteorological deep learning model 300 enhanced based on LLM text obtained by pre-training. The above operation S210 may include: tokenizing the meteorological raster data into a plurality of sequence segments, where the plurality of sequence segments characterize the same spatial resolution; performing a linear transformation on the plurality of sequence segments to obtain a sequence vector representation; aggregating the sequence vector representation to obtain a plurality of sequence aggregation vectors; fusing the plurality of sequence aggregation vectors corresponding to the plurality of sequence segments to obtain a raster aggregation vector; and determining the meteorological feature vector according to the raster aggregation vector.

In the application process, the deep learning module 310 may use an input of shape F×D×L, where F refers to the number of input variables, and the input variables may be weather conditions or meteorological factors. D and L refer to the spatial resolution of the input data, which depends on the density of the earth grid. This general representation may flexibly handle a variety of downstream tasks in earth system science.

As shown in FIG. 3B, the variable tokenization module 311 may first tokenize the input of shape F×D×L as a sequence (D/p)×(L/p)=d×l to obtain F×d×l sequence segments 311_1, and may linearly embed each segment into a vector of dimension H to obtain a sequence vector representation 311_2 with output dimension F×d×l×H as the output of the variable tokenization module 311, where p is patch size, representing image block.

In the process of implementing the concept of the present disclosure, the inventor found that while the variable tokenization module alleviates the training of irregular data sets, it also brings problems such as the computational complexity increases with the input variables and the sequence is easy to contain labels of different variables with different physical bases.

According to the embodiments of the present disclosure, the output of the variable tokenization module 311 may be further processed in combination with the variable aggregation module 312. The variable aggregation module 312 may perform aggregation processing in a cross-attention manner, and may not be limited thereto.

As shown in FIG. 3B, the variable aggregation module 312 may perform a cross-attention operation on each spatial position in d×l. In the process of performing the cross-attention operation, Q (query) may be a learnable vector, and K (Key) and V (Value) may be F embedding vectors of F variables at the position. The variable aggregation module 312 may output a single vector for each spatial position, thereby reducing the sequence length of F×d×l×H to d×l, and obtaining a sequence aggregation vector 312_1 with a sequence length of d×l, and the sequence now contains a unified token with common semantics. Next, the variable aggregation module 312 may fuse the plurality of sequence aggregation vectors 312_1 to obtain a raster aggregation vector 312_2 as the output of the variable aggregation module 312.

According to the embodiments of the present disclosure, after obtaining the raster aggregation vector, if a lead time embedding module 313 and a lead position embedding module 314 are not added to the deep learning module 310, the raster aggregation vector 312_2 may be determined as the meteorological feature vector 315 obtained by extracting the meteorological raster data.

Through the above embodiments of the present disclosure, by tokenizing the meteorological raster data as the plurality of sequence segments with the same spatial resolution, the irregular data set may also be flexibly processed. By aggregating the sequence vector representation of the plurality of training segments, an embedding vector of equal size may be output for each spatial position, thereby reducing the computational cost.

As shown in FIG. 3B, at least one of the lead time embedding module 313 and the lead position embedding module 314 may also be added to the deep learning module 310. The lead time embedding module 313 and the lead position embedding module 314 may be a single-layer MLP.

According to the embodiments of the present disclosure, by adding a lead time embedding module 313 to the deep learning module 310, a pre-trained model generally applicable to various time prediction tasks may be constructed. The time prediction task may characterize a prediction of meteorological data for a certain time period. By adding the lead position embedding module 314 to the deep learning module 310, a pre-trained model generally applicable to various region prediction tasks may be constructed. The region prediction task may characterize a prediction of meteorological data for a certain region.

Taking the pre-trained model for implementing the time prediction task as an example, during the pre-training period, the latitude weighted mean square error may be used to construct a loss function as shown in equation (1), and the lead time information provided by the lead time embedding module 313 may be randomized from 6 hours to 168 hours (one week), which is not limited to this, so as to support the implementation of the time prediction task.

$$Y = \frac{1}{F \times D \times L} {\sum }_{f = 1}^{F} {\sum }_{i = 1}^{D} {\sum }_{j = 1}^{L} L ( i ) {( {\tilde{X}}_{t + Δ t}^{f , i , j} - {X}_{t + Δ t}^{f , i , j} )}^{2} \qquad Equation ( l )$$

In equation (1), t is information of the target time period, Δt is lead time information which may be randomly generated, L(i) is a latitude weighting factor, X_{t+Δt}^{f,i,j} is a predicted result of a time period t+Δt, and X_{t+Δt}^{f,i,j} is an actual result of the time period t+Δt. The determination method is shown in equation (2).

$$L ( i ) = \frac{cos ( lat ( i ) )}{\frac{1}{H} {Σ}_{{i}^{′} = 1}^{H} cos ( lat ( {i}^{′} ) )} \qquad Equation ( 2 )$$

In equation (2), lat(i) is a latitude corresponding to an i-th row of a grid, and i′ represents an index variable, which is used to traverse all the latitude information in the grid when calculating the latitude weighting factor. The latitude weighting factor may explain regional unevenness when drawing the earth grid. For example, grid cells near the equator have larger areas than grid cells near the poles, so more weights should be assigned.

The pre-training process of the pre-trained model for region prediction tasks is similar to the pre-training process of the pre-trained model for time prediction tasks. It is only needed to replace the lead time information in the loss function with the lead position information, which will not be repeated here.

After the pre-training process of the above framework, the deep learning model that learns to perceive a large amount of meteorological data may be obtained. When it is necessary to predict a specific task for different downstream meteorological tasks, it is only needed to select the corresponding loss function for fine-tuning. The prediction head may select models such as MLP, but it is not limited to this.

It should be noted that the pre-training framework shown in FIG. 3A and FIG. 3B is only an exemplary embodiment, but the present disclosure is not limited to the pre-training method, and the architecture and pre-training strategy of other meteorological large models may be applied to the method of determining meteorological information of the present disclosure.

According to the embodiments of the present disclosure, determining the meteorological feature vector according to the sequence aggregation vector may further include: fusing at least one of the lead time embedding information and the lead position embedding information with the raster aggregation vector to obtain the meteorological feature vector.

Referring to FIG. 3B, when at least one of the lead time embedding module 313 and the lead position embedding information 314 is added to the deep learning module 310, at least one of the lead time embedding information provided by the lead time embedding module 313 and the lead position embedding information provided by the lead position embedding module 314 may be added to the raster aggregation vector 312_2 to obtain the meteorological feature vector 315, so that at least one of the lead time embedding information and the lead position embedding information may be combined later to perform the time prediction task and the region prediction task.

Through the above-mentioned embodiments of the present disclosure, by providing the lead time embedding information and the lead position embedding information, the meteorological information determination task of the time dimension and the region dimension may be implemented, which is conducive to expanding the application scenario of the method of determining meteorological information.

According to the embodiments of the present disclosure, after the meteorological raster data of different time and space multimodalities are aggregated based on the deep learning module 310, it is possible to consider pre-training and generating LLM on a large text corpus, so as to better mine the potential information of the to-be-processed meteorological data and improve the effect of the pre-training model.

According to the embodiments of the present disclosure, LLM may be set in the text generation enhancement module 320.

As shown in FIG. 3B, a LLM 322 may be defined in the text generation enhancement module 320, and the LLM 332 may capture the contextual understanding of the to-be-processed meteorological data x and generate a text summary sₓ=Mₐ(p_{c}(x)), where Mₐ represents LLM 322, and p_{c}(x) is a prompt indicating LLM to contextualize x.

According to the embodiments of the present disclosure, after obtaining the to-be-processed meteorological data, the text generation enhancement module 320 in the meteorological deep learning model 300 enhanced based on LLM text obtained by pre-training may be combined to perform the above operation S220. The operation S220 may include: generating a target text information characterizing derived meteorological data according to at least one of the basic meteorological data, an information of the target time period and the location information of the target region; and generating the text summary according to a context information of the basic meteorological data and the target text information.

According to the embodiments of the present disclosure, the derived meteorological data may characterize data that may not be directly collected from climate data sets such as CMIP6 and EAR5 and needs to be calculated based on the basic meteorological data. For example, the derived meteorological data may characterize the overall meteorological information of a region that needs to be determined based on the basic meteorological information of each location in the region, or may characterize the meteorological change information of a region within a preset time period that needs to be predicted based on the basic meteorological information of the region within a target time period, or may characterize a meteorological change information of a region adjacent to a target region that needs to be predicted based on the basic meteorological information of the target region, and may not be limited thereto.

According to the embodiments of the present disclosure, at least one of the basic meteorological data, the information of the target time period, and the location information of the target region may be input into the pre-trained large language model, and the target text information for determining the derived meteorological data is output. The text summary may include only the target text information, or include the context information of the basic meteorological data and the target text information, which is not limited here.

To achieve the above purpose, for example, the basic meteorological data may be used as input of LLM 322, and an information including text information of “determining derived meteorological data of certain attributes” may be used as output of the large language model to train the large language model. When put into use, the to-be-processed meteorological data 321 collected based on climate data sets such as CMIP6 and EAR5 may be input into LLM 322, and a text summary 323_1 including the above target text information may be output.

Based on the text summary, a prediction task may be generated.

According to the embodiments of the present disclosure, since the meteorological data has typical time series, the basic meteorological data may include meteorological time series data. The above-mentioned generating the target text information characterizing the derived meteorological data based on at least one of the basic meteorological data, the information of the target time period, and the location information of the target region may include: generating a first text information based on the information of the target time period, where the first text information characterizes a meteorological change in a preset time period after the target time period; and determining the target text information according to the first text information.

To achieve this purpose, for example, historical meteorological time series data may be used as the input of the large language model, and an information including the text information of “predicting a meteorological change in a future time period” may be used as the output of the large language model to train the large language model. When put into use, the meteorological time series data in the first time period may be input into the large language model, and the text summary of the first text information including “predicting a meteorological change in a second time period” may be output.

Based on this embodiment, the time prediction task may be constructed.

According to the embodiments of the present disclosure, considering the business demand for predicting meteorological information in adjacent regions, the above-mentioned generating the target text information characterizing the derived meteorological data based on at least one of the basic meteorological data, the information of the target time period, and the location information of the target region may include: generating a second text information based on the location information of the target region, where the second text information characterizes a meteorological change in an extended region adjacent to the target region; and determining the target text information according to the second text information.

To achieve this goal, for example, basic meteorological data of the target region may be used as the input of the large language model, and an information including the text information “a meteorological change in the extended region adjacent to the target region” may be used as the output of the large language model to train the large language model. When put into use, the location information and basic meteorological data of the target region may be input into the large language model, and the text summary including the second text information “predicting a meteorological change in a certain extended region” may be output.

Based on this embodiment, the region prediction task may be constructed.

Through the embodiments of the present disclosure, the large language model may make full use of its rich semantic and contextual understanding capabilities, discover features that are ignored by traditional time series data processing models, provide richer information for the overall method of determining meteorological information, and improve the accuracy of downstream prediction tasks.

According to the embodiments of the present disclosure, after obtaining the text summary and the meteorological feature vector, the operation S230 may be performed in combination with the text generation enhancement module 320 and the transformer 330 in the meteorological deep learning model 300 enhanced based on LLM text obtained by pre-training. The operation S230 may include: performing a linear transformation on the text summary to obtain a summary vector representation, where a vector dimension of the summary vector representation is the same as a vector dimension of the meteorological feature vector; fusing the meteorological feature vector with the summary vector representation to obtain a fused feature vector; and determining the fused feature vector as the information enhancement result.

According to the embodiments of the present disclosure, after obtaining the text summary, a linear transformation is needed to be performed on the text summary to obtain the summary vector representation. The process of the linear transformation processing may be implemented by setting a linear transformation module in the text generation enhancement module 320, or by setting a linear transformation module in the transformer 330, which is not limited here.

As shown in FIG. 3B, in order to use the text summary for the ViT framework, a linear transformation module may be constructed in the text generation enhancement module 320 by using a combination of CLS Token and Linear Classifier, and the text summary output by LLM 322 may be linearly transformed to obtain a summary vector representation 323_2, and the vector dimension of the summary vector representation 323_2 is kept the same as the vector dimension of the meteorological feature vector 315. After that, the meteorological feature vector 315 and the summary vector representation 323_2 may be input into the transformer 330 for fusion to obtain a fused feature vector. The fused feature vector may be used as an information enhancement result, and after the self-attention-based encoding and self-attention-based decoding processing in the transformer 330, the meteorological information determination result output for the to-be-processed meteorological data may be obtained.

According to the embodiments of the present disclosure, corresponding to the above-mentioned time prediction task, in the process of fusing the meteorological feature vector with the summary vector representation, the method may further include: acquiring a time information characterizing a to-be-determined preset time period in the text summary from the summary vector representation; and fusing the time information with the lead time embedding information.

For example, given a short-term weather Xₜ of the shape F×D×L in a specific time t, the text summary output by the large language model may include “determine the weather X_{t-Δt} after Δt”, where Δt may be obtained from the summary vector representation of the text summary. In the fusion process, Δt is fused to the lead time embedding information in the meteorological feature vector, and the obtained fused feature vector may include the meteorological feature vector enhanced by the summary vector representation. The weather X_{t+Δt} after Δt may be obtained by combining with the subsequent transformer self-attention processing.

According to the embodiments of the present disclosure, corresponding to the above-mentioned region prediction task, in the process of fusing of the meteorological feature vector with the summary vector representation, the method may further include: acquiring a position information characterizing a to-be-determined extended region in the text summary from the summary vector representation; and fusing the position information of the extended region with the lead position embedding information.

For example, given the weather X_{d} of the shape F×D×L in a specific region d, the text summary output by the large language model may include “determine the weather X_{d′} in the region d′”, where d′ may be obtained from the summary vector representation of the text summary. In the fusion process, d′ is fused with the lead position embedding information in the meteorological feature vector. The obtained fused feature vector may include the meteorological feature vector enhanced by the summary vector representation. The weather X_{d′} in region d′ may be obtained by combining with the subsequent self-attention processing of transformer.

It should be noted that each module in the model architecture shown in FIG. 3A and FIG. 3B may be implemented using any neural network unit with corresponding functions, and the method of determining meteorological information disclosed in the present disclosure may not be limited to the model architecture shown in FIG. 3A and FIG. 3B, but may also be implemented by training deep learning models of other structures, which are not limited here.

Through the embodiments of the present disclosure, it is possible to effectively achieve the expansion of meteorological data scale and meteorological data modality, and utilize the unique generated text generation enhancement module to optimize data feature extraction, so as to achieve more accurate prediction of downstream meteorological tasks. Specifically, the biggest innovation of this solution is the text generation enhancement module based on the large language model. The text summary is generated based on the to-be-processed meteorological data, and usually contains the core points and key information in the text, which are often crucial for the prediction task. By focusing on these key information, the model may more accurately capture the intention and theme of the text, better explore the potential features of the to-be-processed meteorological data, enhance the training and reasoning effects of the large meteorological model, and improve the performance of downstream prediction tasks. Combined with labeling processing and cross-attention operations, it can process various types of irregular data and effectively improve the efficiency and versatility of calculations.

FIG. 4 schematically shows a block diagram of an apparatus of determining meteorological information according to the embodiments of the present disclosure.

As shown in FIG. 4, the apparatus of determining meteorological information 400 includes a feature extraction module 410, a large language model module 420, an information enhancement module 430 and a self-attention processing module 440.

The feature extraction module 410 is configured to perform a feature extraction on meteorological raster data of a target region within a target time period to obtain a meteorological feature vector.

The large language model module 420 is configured to input to-be-processed meteorological data of the target region within the target time period into a large language model to obtain a text summary including a meteorological information determination manner.

The information enhancement module 430 is configured to perform an information enhancement processing on the meteorological feature vector by using the text summary to obtain an information enhancement result.

The self-attention processing module 440 is configured to perform a self-attention processing on the information enhancement result to obtain a meteorological information determination result output for the to-be-processed meteorological data.

According to the embodiments of the present disclosure, the to-be-processed meteorological data includes basic meteorological data and a location information of the target region. The large language model module includes a target text generation unit and a text summary generation unit.

The target text generation unit is configured to generate a target text information characterizing derived meteorological data according to at least one of the basic meteorological data, an information of the target time period and the location information of the target region.

The text summary generation unit is configured to generate the text summary according to a context information of the basic meteorological data and the target text information.

According to the embodiments of the present disclosure, the basic meteorological data includes meteorological time series data. The target text generation unit includes a first text generation sub-unit and a first text generation sub-unit.

The first text generation sub-unit is configured to generate a first text information according to the information of the target time period, where the first text information characterizes a meteorological change within a preset time period after the target time period.

The first text generation sub-unit is configured to determine the target text information according to the first text information.

According to the embodiments of the present disclosure, the target text generation unit includes a second text generation sub-unit and a second target text determination sub-unit.

The second text generation sub-unit is configured to generate a second text information according to the location information of the target region, where the second text information characterizes a meteorological change in an extended region adjacent to the target region.

The second target text determination sub-unit is configured to determine the target text information according to the second text information.

According to the embodiments of the present disclosure, the feature extraction module includes a tokenization unit, a first linear transformation unit, an aggregation unit, a first fusion unit and a meteorological feature vector determination unit.

The tokenization unit is configured to tokenize the meteorological raster data into a plurality of sequence segments, where the plurality of sequence segments characterize the same spatial resolution.

The first linear transformation unit is configured to perform a linear transformation on the plurality of sequence segments to obtain a sequence vector representation.

The aggregation unit is configured to aggregate the sequence vector representation to obtain a plurality of sequence aggregation vectors.

The first fusion unit is configured to fuse the plurality of sequence aggregation vectors corresponding to the plurality of sequence segments to obtain a raster aggregation vector.

The meteorological feature vector determination unit is configured to determine the meteorological feature vector according to the raster aggregation vector.

According to the embodiments of the present disclosure, the meteorological feature vector determination unit includes a fusion sub-unit.

The fusion sub-unit is configured to fuse at least one of a lead time embedding information and a lead position embedding information with the raster aggregation vector to obtain the meteorological feature vector.

According to the embodiments of the present disclosure, the information enhancement module includes a second linear transformation unit, a second fusion unit and an information enhancement result determination unit.

The second linear transformation unit is configured to perform a linear transformation on the text summary to obtain a summary vector representation, where a vector dimension of the summary vector representation is the same as a vector dimension of the meteorological feature vector.

The second fusion unit is configured to fuse the meteorological feature vector with the summary vector representation, so as to obtain a fused feature vector.

The information enhancement result determination unit is configured to determine the fused feature vector as the information enhancement result.

According to the embodiments of the present disclosure, the meteorological feature vector includes a lead time embedding information. The second fusion unit includes a time information acquisition sub-unit and a time information embedding sub-unit.

The time information acquisition sub-unit is configured to acquire a time information characterizing a to-be-determined preset time period in the text summary from the summary vector representation.

The time information embedding sub-unit is configured to fuse the time information with the lead time embedding information.

According to the embodiments of the present disclosure, the meteorological feature vector includes a lead position embedding information. The second fusion unit includes a location information acquisition sub-unit and a location information embedding sub-unit.

The location information acquisition sub-unit is configured to acquire a position information characterizing a to-be-determined extended region in the text summary from the summary vector representation.

The location information embedding sub-unit is configured to fuse the position information of the extended region with the lead position embedding information.

According to the embodiments of the present disclosure, the present disclosure also provides an electronic device, a readable storage medium and a computer program product.

According to the embodiments of the present disclosure, an electronic device is provided, including: at least one processor; and a memory communicatively connected with the at least one processor; where the memory stores instructions executable by the at least one processor, and the instructions, when executed by the at least one processor, cause the at least one processor to perform the method of determining meteorological information.

According to the embodiments of the present disclosure, a non-transitory computer-readable storage medium storing computer instructions is provided, where the computer instructions are configured to cause a computer to perform the method of determining meteorological information.

According to the embodiments of the present disclosure, a computer program product including a computer program is provided, where the computer program is stored in at least one of a readable storage medium and an electronic device, and the computer program, when executed by a processor, implements the method of determining meteorological information.

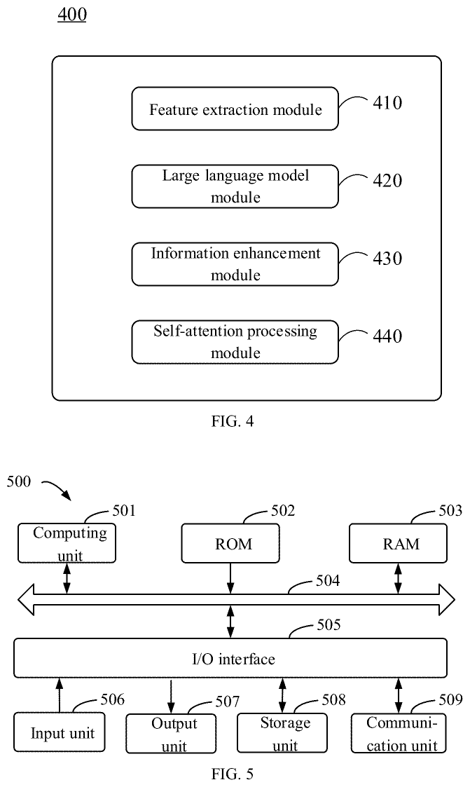

FIG. 5 shows a schematic block diagram of an example electronic device used to implement the embodiments of the present disclosure. The electronic device is intended to represent various forms of digital computers, such as laptop computers, desktop computers, workstations, personal digital assistants, servers, blade servers, mainframe computers and other suitable computers. The electronic device may also represent various forms of mobile devices, such as personal digital processing, cellular phones, smart phones, wearable devices and other similar computing devices. The components shown herein, their connections and relationships, and their functions are merely examples, and are not intended to limit the implementation of the present disclosure described and/or required herein.

As shown in FIG. 5, the device 500 includes a computing unit 501, which may execute various appropriate actions and processing according to a computer program stored in a read only memory (ROM) 502 or a computer program loaded from a storage unit 508 into a random access memory (RAM) 503. Various programs and data required for the operation of the device 500 may also be stored in the RAM 503. The computing unit 501, the ROM 502 and the RAM 503 are connected to each other through a bus 504. An input/output (I/O) interface 505 is also connected to the bus 504.

The I/O interface 505 is connected to a plurality of components of the device 500, including: an input unit 506, such as a keyboard, a mouse, etc.; an output unit 507, such as various types of displays, speakers, etc.; a storage unit 508, such as a magnetic disk, an optical disk, etc.; and a communication unit 509, such as a network card, a modem, a wireless communication transceiver, etc. The communication unit 509 allows the device 500 to exchange information/data with other devices through the computer network such as the Internet and/or various telecommunication networks.

The computing unit 501 may be various general-purpose and/or special-purpose processing components with processing and computing capabilities. Some examples of computing unit 501 include, but are not limited to, central processing unit (CPU), graphics processing unit (GPU), various dedicated artificial intelligence (AI) computing chips, various processors that run machine learning model algorithms, digital signal processing DSP and any appropriate processor, controller, microcontroller, etc. The computing unit 501 executes the various methods and processes described above, such as the method of determining meteorological information. For example, in some embodiments, the method of determining meteorological information may be implemented as computer software programs, which are tangibly contained in the machine-readable medium, such as the storage unit 508. In some embodiments, part or all of the computer program may be loaded and/or installed on the device 500 via the ROM 502 and/or the communication unit 509. When the computer program is loaded into the RAM 503 and executed by the computing unit 501, one or more steps of the method of determining meteorological information described above may be executed. Alternatively, in other embodiments, the computing unit 501 may be configured to execute the method of determining meteorological information in any other suitable manner (for example, by means of firmware).

Various implementations of the systems and technologies described in the present disclosure may be implemented in digital electronic circuit systems, integrated circuit systems, field programmable gate arrays (FPGA), application specific integrated circuits (ASIC), application-specific standard products (ASSP), system-on-chip SOC, load programmable logic device (CPLD), computer hardware, firmware, software and/or their combination. The various implementations may include: being implemented in one or more computer programs, the one or more computer programs may be executed and/or interpreted on a programmable system including at least one programmable processor, the programmable processor may be a dedicated or general programmable processor. The programmable processor may receive data and instructions from a storage system, at least one input device and at least one output device, and the programmable processor transmit data and instructions to the storage system, the at least one input device and the at least one output device.

The program code used to implement the method of the present disclosure may be written in any combination of one or more programming languages. The program codes may be provided to the processors or controllers of general-purpose computers, special-purpose computers or other programmable data processing devices, so that the program code enables the functions/operations specific in the flowcharts and/or block diagrams to be implemented when the program code executed by a processor or controller. The program code may be executed entirely on the machine, partly executed on the machine, partly executed on the machine and partly executed on the remote machine as an independent software package, or entirely executed on the remote machine or server.

In the context of the present disclosure, the machine-readable medium may be a tangible medium, which may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage media would include electrical connections based on one or more wires, portable computer disks, hard disks, random access memory (RAM), read only memory (ROM), erasable programmable read only memory (EPROM or flash memory), optical fiber, portable compact disk read only memory (CD-ROM), optical storage device, magnetic storage device or any suitable combination of the above-mentioned content.

In order to provide interaction with users, the systems and techniques described here may be implemented on a computer, the computer includes: a display device (for example, a CRT (cathode ray tube) or LCD (liquid crystal display) monitor) for displaying information to the user; and a keyboard and a pointing device (for example, a mouse or trackball). The user may provide input to the computer through the keyboard and the pointing device. Other types of devices may also be used to provide interaction with users. For example, the feedback provided to the user may be any form of sensory feedback (for example, visual feedback, auditory feedback or tactile feedback); and any form (including sound input, voice input, or tactile input) may be used to receive input from the user.

The systems and technologies described herein may be implemented in a computing system including back-end components (for example, as a data server), or a computing system including middleware components (for example, an application server), or a computing system including front-end components (for example, a user computer with a graphical user interface or a web browser through which the user may interact with the implementation of the system and technology described herein), or in a computing system including any combination of such back-end components, middleware components or front-end components. The components of the system may be connected to each other through any form or medium of digital data communication (for example, a communication network). Examples of communication networks include: local region network (LAN), wide region network (WAN) and the Internet.

The computer system may include a client and a server. The client and the server are generally far away from each other and usually interact through the communication network. The relationship between the client and the server is generated by computer programs that run on the respective computers and have a client-server relationship with each other.

It should be understood that the various forms of processes shown above may be used to reorder, add or delete steps. For example, the steps described in the present disclosure may be executed in parallel, sequentially or in a different order, as long as the desired result of the present disclosure may be achieved, which is not limited herein.

The above-mentioned specific implementations do not constitute a limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method of determining meteorological information, comprising:
performing a feature extraction on meteorological raster data of a target region within a target time period to obtain a meteorological feature vector;
inputting to-be-processed meteorological data of the target region within the target time period into a large language model to obtain a text summary comprising a meteorological information determination manner;
performing an information enhancement processing on the meteorological feature vector by using the text summary to obtain an information enhancement result; and
performing a self-attention processing on the information enhancement result to obtain a meteorological information determination result output for the to-be-processed meteorological data.

2. The method according to claim 1, wherein the to-be-processed meteorological data comprises basic meteorological data and a location information of the target region; and the inputting to-be-processed meteorological data of the target region within the target time period into a large language model to obtain a text summary comprising a meteorological information determination manner comprises:
generating a target text information characterizing derived meteorological data according to at least one of the basic meteorological data, an information of the target time period and the location information of the target region; and
generating the text summary according to a context information of the basic meteorological data and the target text information.

3. The method according to claim 2, wherein the basic meteorological data comprises meteorological time series data; and the generating a target text information characterizing derived meteorological data according to at least one of the basic meteorological data, an information of the target time period and the location information of the target region comprises:
generating a first text information according to the information of the target time period, wherein the first text information characterizes a meteorological change within a preset time period after the target time period; and
determining the target text information according to the first text information.

4. The method according to claim 2, wherein the generating a target text information characterizing derived meteorological data according to at least one of the basic meteorological data, an information of the target time period and the location information of the target region comprises:
generating a second text information according to the location information of the target region, wherein the second text information characterizes a meteorological change in an extended region adjacent to the target region; and
determining the target text information according to the second text information.

5. The method according to claim 1, wherein the performing a feature extraction on meteorological raster data of a target region within a target time period to obtain a meteorological feature vector comprises:
tokenizing the meteorological raster data into a plurality of sequence segments, wherein the plurality of sequence segments characterize the same spatial resolution;
performing a linear transformation on the plurality of sequence segments to obtain a sequence vector representation;
aggregating the sequence vector representation to obtain a plurality of sequence aggregation vectors;
fusing the plurality of sequence aggregation vectors corresponding to the plurality of sequence segments to obtain a raster aggregation vector; and
determining the meteorological feature vector according to the raster aggregation vector.

6. The method according to claim 5, wherein the determining the meteorological feature vector according to the raster aggregation vector comprises:
fusing at least one of a lead time embedding information and a lead position embedding information with the raster aggregation vector to obtain the meteorological feature vector.

7. The method according to claim 1, wherein the performing an information enhancement processing on the meteorological feature vector by using the text summary to obtain an information enhancement result comprises:
performing a linear transformation on the text summary to obtain a summary vector representation, wherein a vector dimension of the summary vector representation is the same as a vector dimension of the meteorological feature vector;
fusing the meteorological feature vector with the summary vector representation, so as to obtain a fused feature vector; and
determining the fused feature vector as the information enhancement result.

8. The method according to claim 7, wherein the meteorological feature vector comprises a lead time embedding information; and the fusing the meteorological feature vector with the summary vector representation comprises:
acquiring a time information characterizing a to-be-determined preset time period in the text summary from the summary vector representation; and
fusing the time information with the lead time embedding information.

9. The method according to claim 7, wherein the meteorological feature vector comprises a lead position embedding information; and the fusing the meteorological feature vector with the summary vector representation comprises:
acquiring a position information characterizing a to-be-determined extended region in the text summary from the summary vector representation; and
fusing the position information of the extended region with the lead position embedding information.

10. The method according to claim 2, wherein the performing a feature extraction on meteorological raster data of a target region within a target time period to obtain a meteorological feature vector comprises:
tokenizing the meteorological raster data into a plurality of sequence segments, wherein the plurality of sequence segments characterize the same spatial resolution;
performing a linear transformation on the plurality of sequence segments to obtain a sequence vector representation;
aggregating the sequence vector representation to obtain a plurality of sequence aggregation vectors;
fusing the plurality of sequence aggregation vectors corresponding to the plurality of sequence segments to obtain a raster aggregation vector; and
determining the meteorological feature vector according to the raster aggregation vector.

11. The method according to claim 10, wherein the determining the meteorological feature vector according to the raster aggregation vector comprises:
fusing at least one of a lead time embedding information and a lead position embedding information with the raster aggregation vector to obtain the meteorological feature vector.

12. The method according to claim 3, wherein the performing a feature extraction on meteorological raster data of a target region within a target time period to obtain a meteorological feature vector comprises:
tokenizing the meteorological raster data into a plurality of sequence segments, wherein the plurality of sequence segments characterize the same spatial resolution;
performing a linear transformation on the plurality of sequence segments to obtain a sequence vector representation;
aggregating the sequence vector representation to obtain a plurality of sequence aggregation vectors;
fusing the plurality of sequence aggregation vectors corresponding to the plurality of sequence segments to obtain a raster aggregation vector; and
determining the meteorological feature vector according to the raster aggregation vector.

13. The method according to claim 12, wherein the determining the meteorological feature vector according to the raster aggregation vector comprises:
fusing at least one of a lead time embedding information and a lead position embedding information with the raster aggregation vector to obtain the meteorological feature vector.

14. The method according to claim 4, wherein the performing a feature extraction on meteorological raster data of a target region within a target time period to obtain a meteorological feature vector comprises:
tokenizing the meteorological raster data into a plurality of sequence segments, wherein the plurality of sequence segments characterize the same spatial resolution;
performing a linear transformation on the plurality of sequence segments to obtain a sequence vector representation;
aggregating the sequence vector representation to obtain a plurality of sequence aggregation vectors;
fusing the plurality of sequence aggregation vectors corresponding to the plurality of sequence segments to obtain a raster aggregation vector; and
determining the meteorological feature vector according to the raster aggregation vector.

15. The method according to claim 14, wherein the determining the meteorological feature vector according to the raster aggregation vector comprises:
fusing at least one of a lead time embedding information and a lead position embedding information with the raster aggregation vector to obtain the meteorological feature vector.

16. The method according to claim 2, wherein the performing an information enhancement processing on the meteorological feature vector by using the text summary to obtain an information enhancement result comprises:
performing a linear transformation on the text summary to obtain a summary vector representation, wherein a vector dimension of the summary vector representation is the same as a vector dimension of the meteorological feature vector;
fusing the meteorological feature vector with the summary vector representation, so as to obtain a fused feature vector; and
determining the fused feature vector as the information enhancement result.

17. The method according to claim 3, wherein the performing an information enhancement processing on the meteorological feature vector by using the text summary to obtain an information enhancement result comprises:
performing a linear transformation on the text summary to obtain a summary vector representation, wherein a vector dimension of the summary vector representation is the same as a vector dimension of the meteorological feature vector;
fusing the meteorological feature vector with the summary vector representation, so as to obtain a fused feature vector; and
determining the fused feature vector as the information enhancement result.

18. The method according to claim 4, wherein the performing an information enhancement processing on the meteorological feature vector by using the text summary to obtain an information enhancement result comprises:
performing a linear transformation on the text summary to obtain a summary vector representation, wherein a vector dimension of the summary vector representation is the same as a vector dimension of the meteorological feature vector;
fusing the meteorological feature vector with the summary vector representation, so as to obtain a fused feature vector; and
determining the fused feature vector as the information enhancement result.

19. An electronic device, comprising:
at least one processor; and
a memory communicatively connected with the at least one processor;
wherein the memory stores instructions executable by the at least one processor, and the instructions, when executed by the at least one processor, cause the at least one processor to:
perform a feature extraction on meteorological raster data of a target region within a target time period to obtain a meteorological feature vector;
input to-be-processed meteorological data of the target region within the target time period into a large language model to obtain a text summary comprising a meteorological information determination manner;
perform an information enhancement processing on the meteorological feature vector by using the text summary to obtain an information enhancement result; and
perform a self-attention processing on the information enhancement result to obtain a meteorological information determination result output for the to-be-processed meteorological data.

20. A non-transitory computer-readable storage medium storing computer instructions, wherein the computer instructions are configured to cause a computer to:
perform a feature extraction on meteorological raster data of a target region within a target time period to obtain a meteorological feature vector;
input to-be-processed meteorological data of the target region within the target time period into a large language model to obtain a text summary comprising a meteorological information determination manner;
perform an information enhancement processing on the meteorological feature vector by using the text summary to obtain an information enhancement result; and
perform a self-attention processing on the information enhancement result to obtain a meteorological information determination result output for the to-be-processed meteorological data.
